(19) United States
(12) Patent Application Publication
(10) Pub. No.: US 2025/0119384 A1
(43) Pub. Date: Apr. 10, 2025

(54) TECHNOLOGIES TO ADJUST LINK EFFICIENCY AND BUFFER SIZE

(71) Applicant: Intel Corporation, Santa Clara, CA (US)

(72) Inventors: Hossein FARROKHBAKHT, Toronto (CA); Kartik LAKHOTIA, San Jose, CA (US); Gurpreet Singh KALSI, Portland, OR (US); Fabrizio PETRINI, Menlo Park, CA (US)

(21) Appl. No.: 18/981,356

(22) Filed: Dec. 13, 2024

Related U.S. Application Data
(63) Continuation-in-part of application No. 18/391,521, filed on Dec. 20, 2023.
(60) Provisional application No. 63/546,519, filed on Oct. 30, 2023.
(60) Provisional application No. 63/546,410, filed on Oct. 30, 2023.
(60) Provisional application No. 63/546,505, filed on Oct. 30, 2023.
(60) Provisional application No. 63/546,509, filed on Oct. 30, 2023.
(60) Provisional application No. 63/546,513, filed on Oct. 30, 2023.

(51) Int. Cl. H04L 47/24; H04L 47/12; H04L 47/26

(52) U.S. Cl. CPC H04L 47/24; H04L 47/12; H04L 47/26

(57) ABSTRACT

Examples described herein relate to a switch or router. In some examples, the switch or router is to: based on receipt of a control packet associated with a first link, store the control packet into a first region of memory associated with the first link; based on receipt of a data packet associated with the first link, store the data packet into a second region of memory associated with the first link; based on the control packet and data packet to egress from a same output port, insert a strict subset of content of the control packet into the data packet to form a second data packet; and cause transmission of the second data packet to a device from the output port.

### RELATED APPLICATION

The present application is a continuation-in-part of U.S. patent application Ser. No. 18/391,521, filed Dec. 20, 2023 (Attorney Docket Number AF5238-US), which claims the benefit of priority to U.S. Provisional Application No. 63/546,410, filed Oct. 30, 2023; U.S. Provisional Application No. 63/546,505, filed Oct. 30, 2023; U.S. Provisional Application No. 63/546,519, filed Oct. 30, 2023; U.S. Provisional Application No. 63/546,509, filed Oct. 30, 2023; U.S. Provisional Application No. 63/546,513, filed Oct. 30, 2023. The contents of those applications are incorporated herein in their entirety.

### BACKGROUND

Networks provide connectivity among multiple processors, memory devices, and storage devices for distributed performance of processes. In an end-to-end flow control in a network, packets are categorized into payload packets and control packets. Payload packets carry payload information, such as data. A fraction of network bandwidth used to carry payload determines link efficiency of the network. Assuming the link bandwidth is X GBps and a packet size of X bytes, a link efficiency is represented as:

$$Link Efficiency = \frac{Avg . payload size per packet ( bytes )}{Avg . number of flits per packet * X}$$

Control packets may not carry payloads but send acknowledgements (ACKs) or negative acknowledgements (NACKs) indicating respective packet receipt or non-receipt of a packet. Control packets may carry routing path information and packet drop location for a NACK. Transmission of control packets reduces overall link efficiency of the network because control packets do not carry data.

### BRIEF DESCRIPTION OF THE DRAWINGS

FIG. 1 depicts an example switch.

FIG. 2 depicts an example switch system.

FIG. 3A depicts an example network.

FIG. 3B depicts an example operation.

FIG. 4 depicts an example process.

FIG. 5 depicts an example system.

FIGS. 6A and 6B depict an example of reserving buffer slots for response packets to packets that traverse the routers.

FIGS. 7A-7C demonstrate generating the backward response which uses the buffer slots.

FIG. 8A depicts an example process.

FIG. 8B depicts an example process.

FIG. 9 depicts an example switch.

FIG. 10 depicts an example system.

### DETAILED DESCRIPTION

Various examples can potentially increase link efficiency between routers or network interface devices and prevent blocking of payload packets by control packets by: (a) combining content of a control packet into a payload packet prior to transmission of the payload packet and/or (b) using separate or allocated packet processing circuitry inside routers for processing control and payload packets to avoid blocking of payload packets by control packets. Various examples can configure payload packet and control packet transmissions over a link to permit combining one or more control packets into one or more payload packets, or combining one or more payload packets into one or more control packets.

Various examples can potentially provide one or more of the following advantages, but are not necessary features: improve link efficiency when both control packets and payload packets; reduce a likelihood that payload packets are blocked by control packets at router arbitration; apply to topology types such as high-radix and low-radix routers; apply to different protocol models; apply to shared-memory and distributed-memory communications; apply to different routing schemes (e.g., source routing or destination routing); and/or apply to on-chip and off-chip networks.

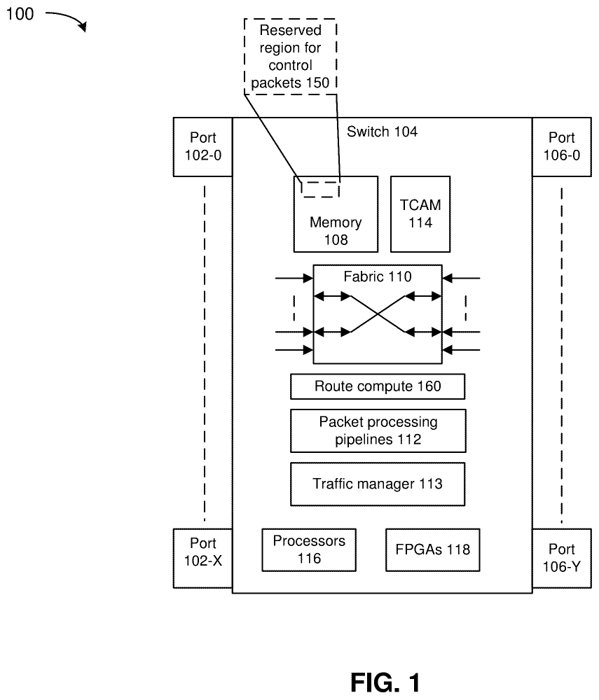

FIG. 1 depicts an example switch. Various examples of switch system 100 can be used in a network on chip (NoC) to perform operations described herein to improve link efficiency by combining payload and control packets, processing payload and control packets using separate paths, allow for egress of packets without receipt of credits from an egress port, and/or issue a NACK based on dropping a received packet. A NoC can attempt to prevent deadlock, which occurs when a group of packets that share some resources remain in a perpetual waiting state due to a circular dependency.

Switch circuitry 104 can route packets, flits, or frames of any format or in accordance with any specification from one or more of ports 102-0 to 102-X to one or more of ports 106-0 to 106-Y (or vice versa), where X and Y are integers. One or more of ports 102-0 to 102-X can be connected to a network of one or more interconnected devices. Similarly, one or more of ports 106-0 to 106-Y can be connected to a network of one or more interconnected devices.

In some examples, switch fabric 110 can provide routing of packets from one or more ingress ports 102-0 to 102-X for processing prior to egress from switch 104. Switch fabric 110 can be implemented as one or more multi-hop topologies, where example topologies include torus, butterflies, buffered multi-stage, etc., or shared memory switch fabric (SMSF), among other implementations. SMSF can be any switch fabric connected to ingress ports and egress ports in the switch, where ingress subsystems write (store) packet segments into the fabric's memory, while the egress subsystems read (fetch) packet segments from the fabric's memory.

Memory 108 can be configured to store packets received at ingress ports 102-0 to 102-X prior to egress from one or more ports. Packet processing pipelines 112 can include ingress and egress packet processing circuitry to respectively process ingressed packets and packets to be egressed. Packet processing pipelines 112 can determine which port to transfer packets or frames to using a table that maps packet characteristics with an associated output port. Packet processing pipelines 112 can be configured to perform match-action on received packets to identify packet processing rules and next hops using information stored in a ternary content-addressable memory (TCAM) tables or exact match tables in some examples. For example, match-action tables or circuitry can be used whereby a hash of a portion of a packet is used as an index to find an entry (e.g., forwarding decision based on a packet header content). Packet processing pipelines 112 can implement access control list (ACL) or packet drops due to queue overflow.

Packet processing pipelines 112, processors 116, FPGAs 118, and/or route compute (RC) circuitry 160 can be configured to combine payload and control packets, process payload packets and control packets in separate paths, allow for egress of packets without receipt of credits from an egress port, and/or issue a NACK based on dropping a received packet, as described herein.

Configuration of operation of packet processing pipelines 112, including its data plane, can be programmed using Programming Protocol-independent Packet Processors (P4), C, Python, Broadcom Network Programming Language (NPL), or x86 compatible executable binaries or other executable binaries.

Traffic manager 113 can perform hierarchical scheduling and transmit rate shaping and metering of packet transmissions from one or more packet queues. Traffic manager 113 can perform congestion management such as flow control, congestion notification message (CNM) generation and reception, priority flow control (PFC), and others.

Components of examples described herein can be enclosed in one or more semiconductor packages. A semiconductor package can include metal, plastic, glass, and/or ceramic casing that encompass and provide communications within or among one or more semiconductor devices or integrated circuits. Various examples can be implemented in a die, in a package, or between multiple packages, in a server, or among multiple servers. A system in package (SiP) can include a package that encloses one or more of: a switch system on chip (SoC), one or more tiles, or other circuitry.

In some examples, switch 100 can include one or more of: a network interface controller (NIC), a remote direct memory access (RDMA)-enabled NIC, SmartNIC, router, switch, forwarding element, infrastructure processing unit (IPU), data processing unit (DPU), or edge processing unit (EPU). An edge processing unit (EPU) can include a network interface device that utilizes processors and accelerators (e.g., digital signal processors (DSPs), signal processors, or wireless specific accelerators for Virtualized radio access networks (vRANs), cryptographic operations, compression/decompression, and so forth). In some examples, network interface device, switch, router, and/or receiver network interface device can be implemented as one or more of: one or more processors; one or more programmable packet processing pipelines; one or more accelerators; one or more application specific integrated circuits (ASICs); one or more field programmable gate arrays (FPGAs); one or more memory devices; one or more storage devices; or others. In some examples, router and switch can be used interchangeably. In some examples, a forwarding element or forwarding device can include a router and/or switch.

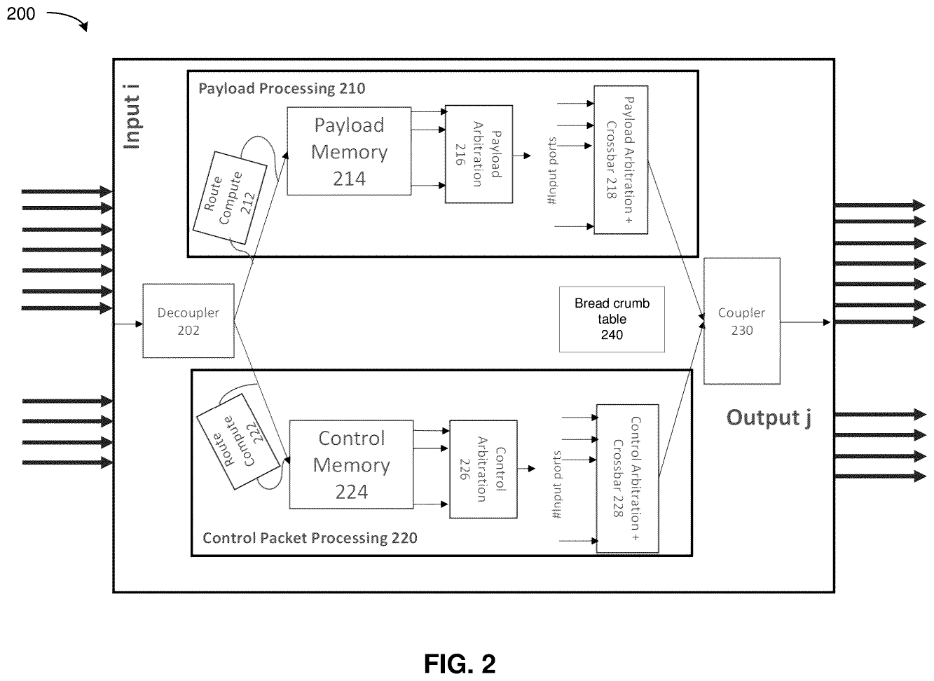

FIG. 2 illustrates an example system. For clarity of description, only one input port and one output port are represented, but system 200 can be applied to multiple input and output ports. Various examples can increase link efficiency for networks by coupling control and payload packets on a per link basis so that packets traversing over network links may include both payload and control packet information. Various examples of selecting control packet information to convey in a payload packet are described herein.

Decoupler circuitry 202 can extract control information from a packet payload and direct content of the payload packet to payload packet processing 210 and the control packet information to control packet processing 220. If the received packet has not been combined and is either payload or control, then decoupler circuitry 202 can direct the packet to the appropriate packet processor, payload packet processing 210 or control packet processing 220. Decoupler circuitry 202 can differentiate these cases by checking the flit header (FH) field of a packet to identify a payload packet or a control packet. For example, an FH field can identify a payload packet as a forward packet or identify a control packet as a backward packet.

System 200 can utilize separate, dedicated, or virtualized packet processors for an input port: payload packet processing 210 and control packet processing 220. To reduce a likelihood of control packets block egress of payload packets, or vice versa, payload packet processing 210 and control packet processing 220 can separately process respective payload and control packets by utilizing partitioned or separate route compute units 212 and 222, arbitrations 216 and 226, and crossbars 218 and 228. Various examples of payload packet processing 210 includes operations described at least with respect to packet processing pipelines 112. Various examples of control packet processing 220 includes responding to a NACK based on source routing (e.g., forwarding the NACK) or destination routing (e.g., retransmitting a packet along a path to avoid a congested switch), or others.

Coupler unit 230 can merge content of a payload packet with content of a control packet, if control packets and payload packets are available to egress from output port j in overlapping clock cycles. For example, coupler unit 230 can copy a strict subset or less than an entirety of content of a control packet into content of a payload packet. For example, where a payload packet is available and no control packet is available after a configured duration of A nanoseconds, the payload packet can be egressed with no coupling with a control packet. For example, where a control packet is available and no payload packet is available after a configured duration of B nanoseconds, the control packet can be egressed with no coupling with a payload packet. For example, where a payload packet is available and a control packet is available within a configured duration of A or B nanoseconds, coupler 230 can include content of such control packet in a header and/or payload of the payload packet. Values of A and B can be configured by a data center administrator, processor-executed driver, orchestrator, or others.

A control packet can include: flit header, sender of the payload packet, destination of the payload packet, Return Code, Injection Tag, Output port retrieved from the breadcrumb table, and local tag. However, content of a control packet may not fit into a reserved field of a payload packet or cause the payload packet size to exceed a peak level (e.g., maximum transmission unit (MTU)). For example, coupler 230 can provide a return code (e.g., ACK/NACK) and a pointer (e.g., local tag) to an entry in a breadcrumb table of a downstream router from a control packet in a payload packet. An entry in the breadcrumb table of the downstream router can store route information of the control packet that is identified by the pointer. As described herein, the entry in the breadcrumb table of the downstream router can store information of the control packet that is not placed into the payload packet based on such information being stored in the downstream router by processing of a forward packet that triggered the transmission of the control packet (e.g., backward packet). A receiver of the combined packet can derive non-transmitted fields of the control packet from an entry identified in bread crumb table by the local tag value. When the control packet with local tag, combined into a payload packet, arrives at a router, the router can form the control packet by retrieving information from an entry in the breadcrumb table identified by the local tag. In some examples, coupler 230 can utilize a breadcrumb table per link pair. A link pair can represent a wired or wireless connection between two network interface devices.

In some examples, payload packet and control packet may have arrived on different input ports but are combined. In other words, the payload packet and the control packet need not have the same routing path to be eligible for combination by coupler 230 provided the payload packet and control packet are to be egressed from the same output port.

A forward message can include one or more packets generated during a forward phase by an initiator. A forward path can include a router path that the forward packets traverse to reach the targets/destinations. In the forward phase, transactions are initiated by generating the forward packets and sending them to their respective destination(s). As these forward packets traverse a path, the input port used to receive the forward packet is recorded by a router, to route backward messages, as described herein, so that forward and backwards packets traverse the same path through routers, but in opposite directions. A forward message can represent various types of requests, including coherent messages, Put and Get operations, or collective messages.

When the forward message is received by the destination(s), the backward phase commences, which can include generating and transmitting a backward message. Backward message can include one or more packets sent by the destination(s) to the initiator of the forward packets over the same path that the forward packet traversed. A backward path can include a router path that the backward packets traverses to reach the initiator of the forward packets. In some examples, packets transmitted in the backward path can use the same intermediate routers as those of the forward path. A backward message may include data, endpoint buffer availability, a transaction result, e.g., ACK/NACK, and other information. ACKs can be sent to the senders when forward packets successfully reach their destinations, and NACKS can be generated when forward packets fail to reach a destination.

In some examples, a forward packet header can include one or more of the following fields of Table 1:

TABLE 1

| Field | Example description |
|---|---|
| Flit header (FH) | Identifies packet type, virtual channel |
| | identifier, and flit position. |
| Local tag | Router assigned tag |
| Forward path/ | The output ports per hop from the source to |
| routing field | destination. This field can be based on source |
| | routing or adjusted by an intermediate router. |
| Current Hop | A pointer to the Forward path field. Router |
| | determines the appropriate output port number |
| | based on current hop. After reading Current |
| | Hop field, router increments the hop count by |
| | one. |
| | This field can be set to a number of hops |
| | between the source and destination. As a |
| | packet passes through a router, the router can |
| | update the hop number by decrementing it by |
| | 1. This field reveals the drop location. |
| Transaction Type | Read, Write, ACK, NACK etc. |

In some examples, a backward packet header can include one or more of the following fields.

TABLE 2

| Field | Example description |
|---|---|
| Result status | ACK/NACK, the reason of failure |
| Hop Number of the | The hop number field of the Forward packet |
| Backward Header | can be carried in this field. |
| Drop Location | Copy of hop number field of the Forward |
| | packet to this field. |
| Telemetry data | Priority level of packet that was dropped. |
| | Congestion information. |

Telemetry data can be included in a packet header or payload. Examples of telemetry data can include congestion information based on High Precision Congestion Control (HPCC) or in-network telemetry (INT). HPCC can utilize in-network telemetry (INT) to convey precise link load information. Note that telemetry data can be utilized in other forward and/or backward packet formats described herein.

Some examples eliminate a need for storing the routing information in the header of backward packets, reducing overhead in backward packets.

In some examples, a flit header can include one or more of the following fields:

TABLE 3

| Field | Example description |
|---|---|
| Packet Type | Forward or Backward |
| VC ID | The virtual channel number the packet is using. |
| Flit type | Head, tail, body, head-tail |

Table 4 depicts an example breadcrumb table 240. For a payload packet that is to egress from an output port, coupler 230 can record in an entry associated with the local tag in breadcrumb table 240 one or more of: a local tag value used at the upstream router from the payload packet header, an injection tag value, source identifier (SRC ID), a SRC Injection Port ID, a destination identifier (DST ID), and a DST Ejection Port ID (output port). The incoming port can used to route back a response packet (e.g., backward packet) to the payload packet to the sender of the payload packet (e.g., forward packet). The local tag can represent an index for an entry in breadcrumb table 240 (e.g., 0 to N). The injection tag can identify which payload packet(s) are combined with a control packet. The SRC ID and the SRC Injection Port ID can represent the sender of the payload packet as an incoming port for the payload packet. The DST ID and DST Ejection Port ID can represent the destination of the payload packet.

TABLE 4

| | | | | | |
|---|---|---|---|---|---|
| Local | Injection | SRC | SRC injection | DST | DST ejection |
| tag | tag | ID | port ID | ID | port ID |

0
1
2
3
N

After storing the tag field, the used port, injection tag, and the sender/destination information into an empty entry in breadcrumb table 240, coupler 230 can store the index of the entry in the local tag field of the payload packet.

The local tag can enable the identification of backward packets corresponding to forward packets at the initiator of the forward packets and aid in determining the output port for the backward packets on the return path as the input port identifier can refer to an output port from which to forward the backward packet. The local tag can facilitate delivery of backward packets to their respective sender(s). For example, where a control packet is received that includes merely a Response Code and Local Tag, a switch can determine other fields of the received control packet by retrieving an entry corresponding to the Local Tag from breadcrumb table 240 because the other fields of the received control packet were populated in breadcrumb table 240 from a prior egress of a forward (e.g., payload packet) to which the control packet is a response.

For example, control packets can include the following information in a control packet header:

TABLE 5

| | |
|---|---|
| Field | Example description |
| Flit header (FH) | Identifies packet type, virtual channel identifier, and flit |
| | position. |
| Local Tag | Router assigned tag |
| Sender of the payload packet | SRC ID and SRC Injection Port ID. This is the |
| | destination of the control packet. |
| Destination of the payload packet | DST ID and DST Ejection Port ID |
| Return Code | ACK or the NACK type |
| Injection Tag | The known tag for the sender of the payload packet. |
| | Using this tag, the sender can determine a particular |
| | payload packet corresponds to a particular control packet. |
| Routing information | The routing path to route the control flits from the |
| | destination of the payload packet to the sender of the |
| | payload packet. This field includes a sequence of output |
| | ports per hop. |
| Current Hop | A pointer to the Forward path field. Router determines |
| | the appropriate output port number based on current hop. |
| | After reading Current Hop field, router increments the |
| | hop count by one. |
| | This field can be set to a number of hops between the |
| | source and destination. As a packet passes through a |
| | router, the router can update the hop number by |
| | decrementing it by 1. This field reveals the drop location. |

In some examples, a flit header can include one or more of the following fields:

TABLE 6

| Field | Example description |
|---|---|
| Packet Type | Forward or Backward |
| VC ID | The virtual channel number the packet is using. |
| Flit type | Head, tail, body, head-tail |

At router 200, the packet's local tag in the tag field can be used to retrieve the output port and the downstream tag from breadcrumb table 240 that was generated in the forward phase. Router 200 can substitute content of the received tag with a current tag of the packet, stored in a retrieved entry in the breadcrumb table, before forwarding the backward packet to another network device. The recorded input port can be used to identify the output port for the backward packet when the input port is bidirectional and receives packets from a network device and can also be used as an output port to transmit packets to a network device that was formerly upstream, but becomes a downstream device for the backward packet.

A packet may be used herein to refer to various formatted collections of bits that may be sent across a network, such as Ethernet frames, Internet Protocol (IP) packets, Transmission Control Protocol (TCP) segments, User Datagram Protocol (UDP) datagrams, etc. In some examples, a flow control unit (flit) can represent a portion of a packet and flits can be transmitted between networking devices in a network or NoC. A packet can include one or more flits.

A flow can include a sequence of packets being transferred between two endpoints, generally representing a single session using a known protocol. Accordingly, a flow can be identified by a set of defined tuples and, for routing purpose, a flow is identified by the two tuples that identify the endpoints, e.g., the source and destination addresses. For content-based services (e.g., load balancer, firewall, intrusion detection system, etc.), flows can be differentiated at a finer granularity by using N-tuples (e.g., source address, destination address, IP protocol, transport layer source port, and destination port). A packet in a flow is expected to have the same set of tuples in the packet header. A packet flow to be controlled can be identified by a combination of tuples (e.g., Ethernet type field, source and/or destination IP address, source and/or destination User Datagram Protocol (UDP) ports, source/destination TCP ports, or any other header field) and a unique source and destination queue pair (QP) number or identifier.

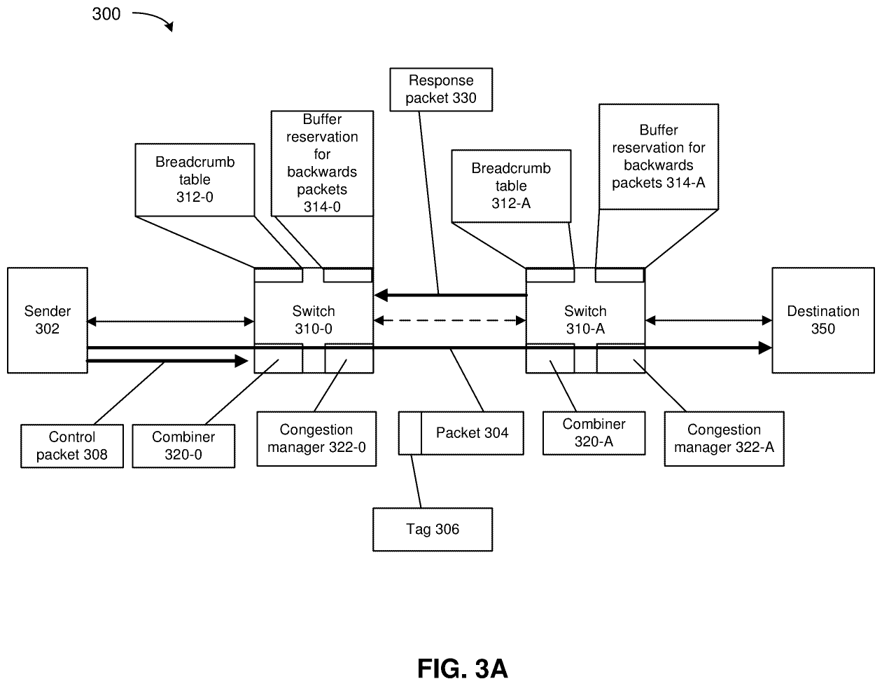

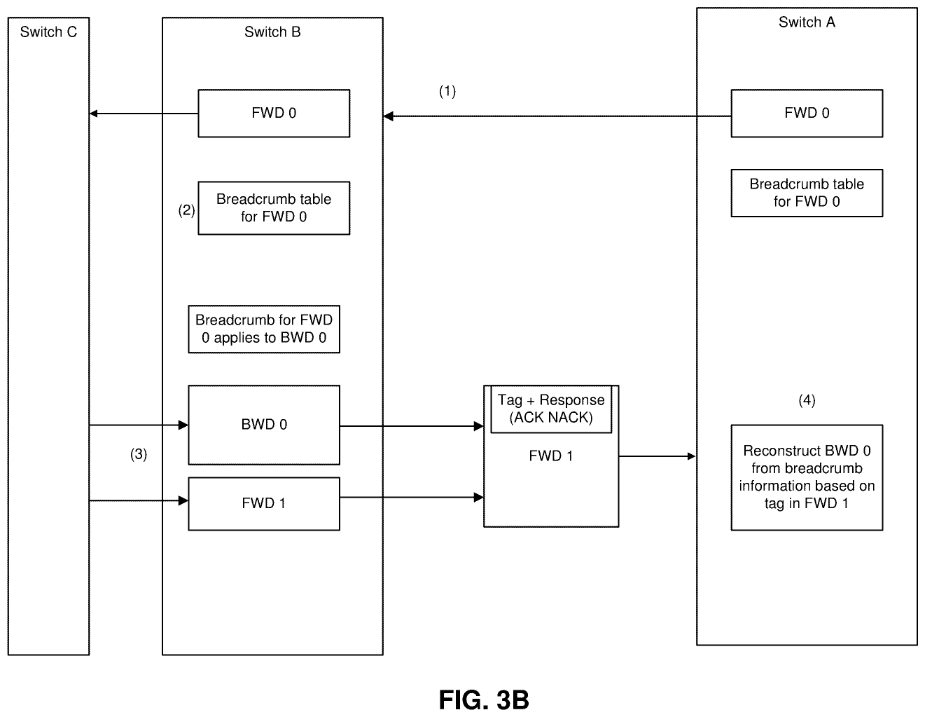

FIG. 3A depicts an example network. Sender 302 can transmit a forward packet 304 to destination 350 via switches 310-0 to 310-A, where A is an integer. Switch 310-0 to 310-A can utilize combiner 320-0 to combine one or more payload packets (e.g., forward packet) with one or more control packets (e.g., backward packets). For example, switch 310-0 can combine a Response Code and Tag 306 from control packet 308 into payload packet 304. Switch 310-0 to 310-A can store packet information of forward packet 304 in an entry identified by tag 306 in respective breadcrumb tables 310-0 to 310-A, for use to route backward packet (e.g., response packet 330) to sender 302 by retrieving information of response packet 330 from a corresponding breadcrumb table. Switch 310-0 to 310-A can reserve buffer 314-0 to 314-A for backwards packet 330 so that backwards packet 330 is not dropped by switch 310-0 to 310-A before receipt by sender 302.

FIG. 3B depicts an example operation. At (1), switch A can transmit forward packet FWD 0 to switch B. At (2), switch A can populate a breadcrumb table entry for forward packet FWD 0 corresponding to a local tag transmitted with FWD 0. In response to receipt of FWD 0, backward packet 0 (BWD 0) can be transmitted from a sender (not shown). At (3), backward packet 0 (BWD 0) and forward packet 1 (FWD 1) from switch C (or different switches or ports) can be combined into FWD 1. A response code and local tag identifying an entry in breadcrumb table associated with FWD 0, and previously stored in switch A, can be included in the combined packet, FWD 1. At (4), switch A can reconstruct control packet BWD 0 based on an entry in a breadcrumb table that stores information of packet FWD 0, to which BWD 0 is a response. A decision of an output port for BWD 0 can be made based on the entry in the bread crumb table and a control packet or payload packet can be combined with BWD 0 to egress from a same output port.

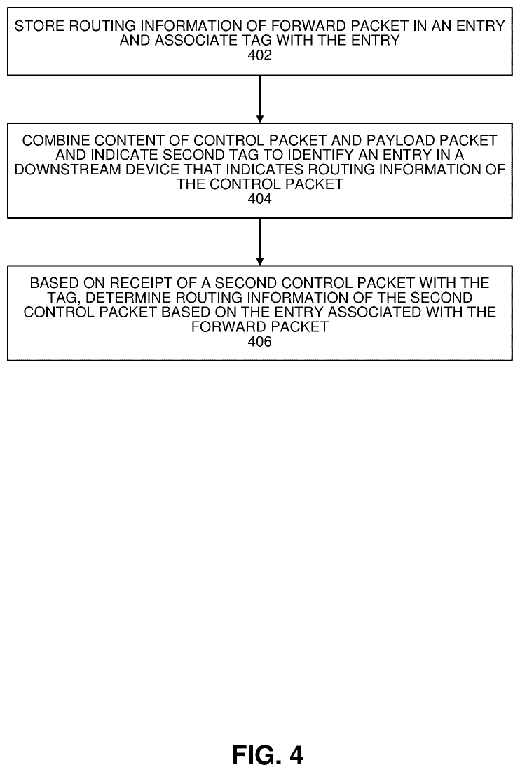

FIG. 4 depicts an example process. The process can be performed by a switch in some examples. At 402, based on receipt of a forward payload packet, an entry can be formed that stores routing information of the forward payload packet and a tag can be associated with the entry. At 404, based on a backward control packet and a second forward payload packet that are to egress from a same output port, content of the backward control packet can be combined into the second forward packet. In some examples, routing information of the backward control packet is not provided in the second forward packet and a second tag is included in the second forward packet to identify an entry in a next hop switch from which to retrieve routing information.

At 406, based on receipt of a second backward control packet responsive to the forward payload packet, routing information for the second backward control packet can be determined by retrieval of the entry as identified by the tag. An upstream sender switch or network interface device can insert the tag into the second backward control packet, even if combined into a third forward packet. The second backward control packet can be combined with a forward payload packet that are to egress the same output port.

### Credit-Free Transmission at Link-Level in High-Performance Networks

Credit counts can be used to indicate available buffer space in a switch. For switches or network interface devices connected by a link, when none of the packets have been sent, a credit count at the upstream switch is equal to the size of the buffer of a downstream switch receive port. When the upstream switch sends a packet to the downstream switch, the credit count reduces by 1. The downstream switch receives the packet and stores the packet in a input buffer. When the downstream switch reads a packet from its input buffer and transmits the packet to another switch or network interface device, the downstream switch sends a credit increase signal to the upstream switch and the upstream switch increases the credit count by 1. If the upstream switch runs out of credits, the upstream switch stops packet transmission until receiving a credit up signal, and the count becomes non-zero again.

If the latency of the link between adjacent switches is 1 clock cycles and d represents a propagation delay of credit up indicator, at least 21+d cycles elapse before the credit lost corresponding to a transmitted packet can be restored again. Such latency can introduce a pause in packet transmission and can lead to less than full utilization of link bandwidth.

To reduce a likelihood of latency arising from credit propagation based on buffer fullness, a size of the input buffer can be increased to accommodate at least as much data as a bandwidth-delay product. However, input buffers can consume switch silicon area (footprint) and power and increasing sizes of input buffers can consume more switch area and power than is available. Various examples provide a credit-free flow control for links between switches or network interface devices that allows an upstream switch to transmit packet without pausing (e.g., at full line rate) even if the downstream switch input buffers do not have enough space to store the received packets. The size of a downstream switch input buffer can be provisioned to account for occupancy based on simulations and not worst case situations and can be smaller than worst case situation.

If the buffer is filled, the downstream switch can drop the arriving packets and send a negative acknowledgement (NACK) to the upstream switch. The reception of a NACK at the upstream switch signals congestion and upstream switch can take appropriate action. For source routing, the source switch can compute an entire path of a packet and the path can be represented as a sequence of output ports to traverse, whereby switches on the patch select an output port from the sequence based on the number of hops incurred, and routes the packet there. In a source routed system, where the entire path is computed at the source network interface device or switch, the upstream switch can propagate the NACK to the source which can re-route the packet on the same or a different path. Destination routing computes a routing path incrementally as the packet hops through the network and a switch at a hop computes the output port of the packet based on its destination and routes the packet to the destination. In destination routed systems, where switches on a path selects output ports, the upstream switch can retry the packet along the same or a different path towards the destination.

Various examples provide a flow control mechanism at the link level where a downstream receiver switch tracks the free space on its buffers, instead of the upstream sender switch tracks the buffer availability on the downstream switch.

Various examples can provide the following advantages, but not necessary features: decouples the bandwidth utilization and buffer size so that buffers do not need to be sized to account for credit up indicator latency or worst case link latency; reduce memory requirements, area, cost, and power of input buffers such as for co-packaged optical switches which have stricter area and power constraints; or can utilize one or multiple virtual channels.

Referring again to FIG. 1, as described herein, RC 160 can allocate region 150 in memory 108 to store control packets that are responsive to packets forwarded by switch 100 so that the control packets can be forwarded to their recipients without being dropped. In some examples, RC 160 can perform one or more congestion mitigation actions based on receipt of an indication of packet non-receipt (e.g., NACK) that includes one or more of: drop a packet to be egressed to a next hop that is not an endpoint and send a NACK for the dropped packet to a sender device, or select another path for packets of one or more flows that are to egress from an output port considered congested.

In a source routed network, where the entire path is computed at the source network interface device or switch, based on receipt of a NACK, route compute unit 160 can propagate the NACK to the source which can re-route the packet on the same or a different path. In a destination routed network, RC 160 can retry the packet along the same or a different path towards the destination network device.

Referring again to FIG. 3A, in some examples, one or more of switches 310-0 to 310-A can utilize congestion manager 322-0 to 322-A to perform one or more congestion mitigation actions based on congestion in an input queue, as described herein.

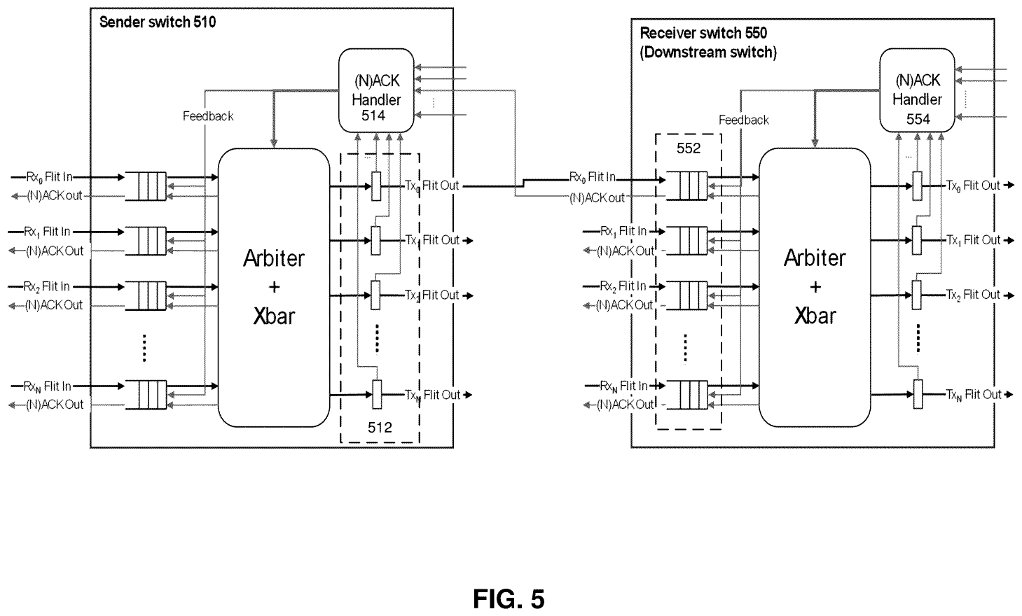

FIG. 5 depicts an example system. Various examples of sender switch 510 can utilize reliable transport protocols to ensure reliable communication by a sender re-transmitting packets that were not received by a receiver, such as where a receiver indicates a particular packet was not received. Examples of reliable transport protocols include at least Transmission Control Protocol (TCP), quick UDP Internet Connections (QUIC), or others. Switch 510 can retain a copy of packets transmitted to switch 550 in buffer 512 until packets are delivered to their respective destinations such as receipt of an ACK.

In downstream switch 550, NACK handler 554 can detect overflow of buffer 552, drop arriving packets, and generate negative acknowledgements (NACKs). Downstream switch 550 accepts packets when there is space in an input buffer 552 but drops a packet when there is no buffer space in buffer 552. When a payload packet is dropped, NACK handler 554 can cause generation of a NACK to be sent to upstream switch 510. Dropping can be performed at either flit granularity or packet granularity, where a packet may comprise of multiple flits. For simplicity of description, the rest of the description follows packet granularity drops but similar methods can be applied for flit granularity drops as well. A NACK can be sent as an independent flit or can be combined with a payload flit that downstream switch 550 sends to upstream switch 510.

Upstream switch 510 can store previously transmitted packets in transmit (Tx) buffer 512 and based on receipt of the NACK, NACK handler 514 can retry transmission of the dropped packet stored in transmit buffer 512 to switch 550. Switch 510 can also propagate the NACK towards the sender of the packet so that switches on the path are notified of congestion at switch 550 and can route subsequent packets along a different path to avoid switch 550 or reduce a rate of transmission of packets to switch 550.

Various congestion control schemes can be applied by switch 550. For example, switch 550 can perform Explicit Congestion Notification (ECN), defined in RFC 3168 (2001), allows end-to-end notification of network congestion whereby the receiver of a packet echoes a congestion indication to a sender. A packet sender can reduce its packet transmission rate in response to receipt of an ECN. Use of ECN can lead to packet drops if detection and response to congestion is slow or delayed. TCP CC is based on heuristics from measures of congestion such as network latency or the number of packet drops.

Switch 550 can perform other congestion control schemes including Google's Swift, Amazon's SRD, and Data Center TCP (DCTCP), described for example in RFC-8257 (2017). DCTCP is a TCP congestion control scheme whereby when a buffer reaches a threshold, packets are marked with ECN and the end host receives markings and sends the marked packets to a sender. The sender can adjust its transmit rate by adjusting a congestion window (CWND) size to adjust a number of sent packets for which acknowledgement of receipt was not received. In response to an ECN, a sender can reduce a CWND size to reduce a number of sent packets for which acknowledgement of receipt was not received. Swift, SRD, DCTCP, and other CC schemes adjust CWND size based on indirect congestion metrics such as packet drops or network latency.

Switch 550 can perform a congestion control scheme such as High Precision Congestion Control (HPCC) for remote direct memory access (RDMA) communications that provides congestion metrics to convey precise link load information. HPCC is described at least in Li et al., “HPCC: High Precision Congestion Control,” SIGCOMM (2019). HPCC leverages in-network telemetry (INT) (e.g., Internet Engineering Task Force (IETF) draft-kumar-ippm-ifa-01, “Inband Flow Analyzer” (February 2019)). HPCC uses in-band telemetry INT to provide congestion metrics measured at intermediary switches.

A sender (e.g., switch 510) can transmit on a link without information about the buffer availability on the downstream switch. Upstream switch 510 does not need to wait for credits to track buffer space in a downstream switch. As the transmission is not stalled by the upstream switch, packets continuously move within the network and no circular dependencies are created. Thus, deadlocks may not occur, unlike in credit-based flow control.

To guarantee the delivery of NACK to a sender that generated a packet was generated, examples can reserve a space in the input buffer of a switch before packet leaves the output stage to the transmit (Tx) link. When a NACK arrives, NACK can be buffered for further routing and not dropped. The NACK can retrace the path taken by the dropped packet using port information stored in the reserved space. Referring again to FIG. 3A, in some examples, one or more of switches 310-0 to 310-A can utilize a buffer reservation policy 314-0 to 314-A to reserve buffers slots in a return path for backward or response packets 330 (e.g., NACKs/ACKs), so that response packets 330 can reach the corresponding senders or switches.

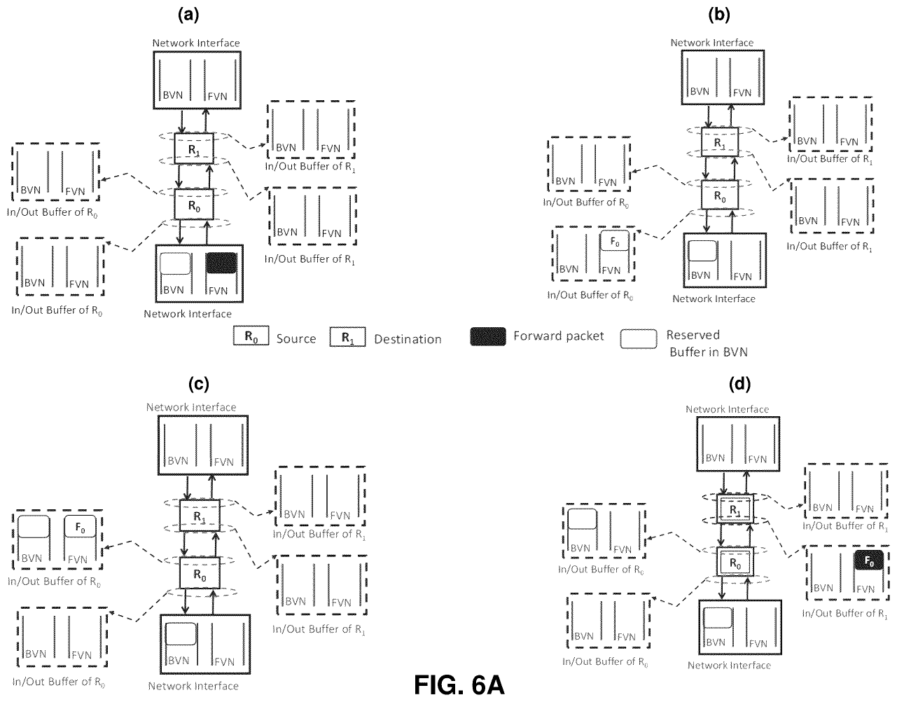

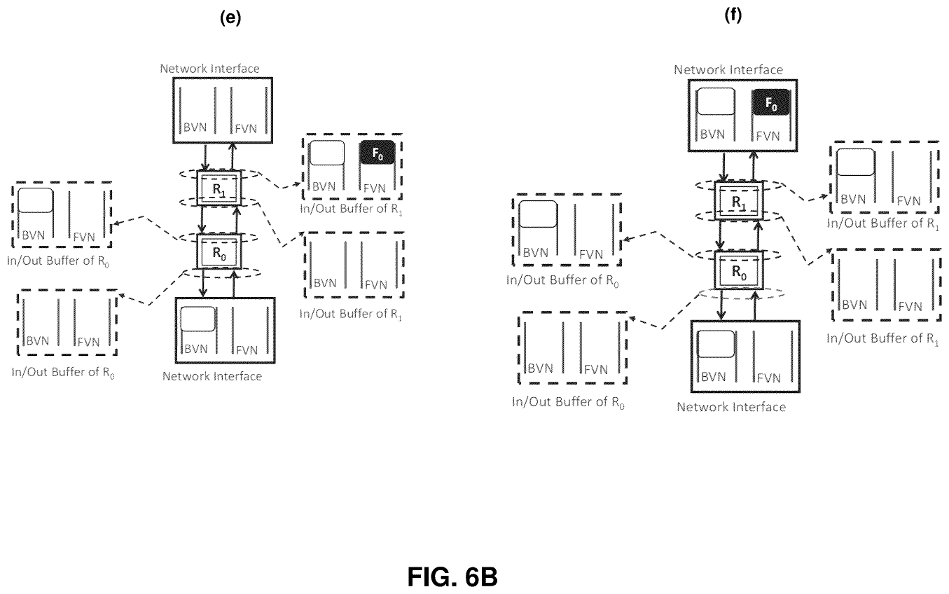

FIGS. 6A and 6B depict an example of reserving buffer slots for response packets to packets that traverse the routers. For the sake of simplicity, only the buffers for one direction are represented, but can be applied in other directions (e.g., east-west, west-east, or south-north). As shown in (a), when forward packet F₀ is placed into the injection queue of the R₀, buffer space is reserved for the future backward packet in the respective backward ejection queue. At (b), once forward packet F₀ resides in the forward input buffer R₀, router R₀ checks the conditions for advancing forward packets. Since the forward downstream buffer of R₀ has enough space and its corresponding backward input buffer is available, the forward packet advances and at (c), the required buffer in the backward packets (e.g., response) (BVN) slot is reserved for the future backward packet. After that, packet F₀ proceeds to the forward input buffer of the next hop in (d). Then, at (e), packet F₀ advances to the forward downstream buffer since it has enough room, and its corresponding backward input buffer can accommodate the future backward packet. Thus, R₁ proactively reserves a backward buffer slot is proactively reserved while the packet traverses to the output stage. As the packet has arrived at its destination, the packet is ejected to the forward packets (FVN) while a room is reserved in the BVN of the network interface (NI) to accommodate the future Backward packet at (f).

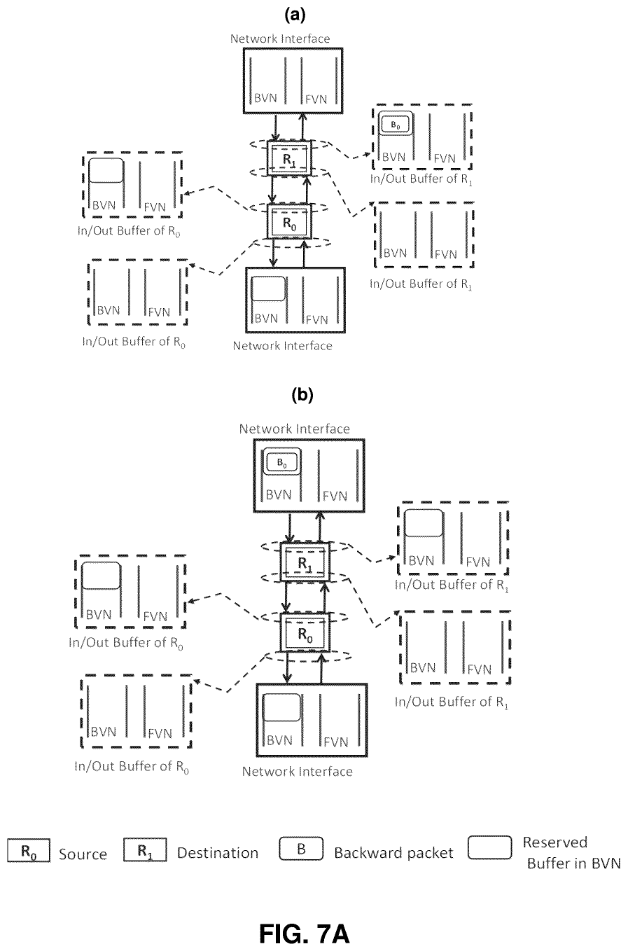

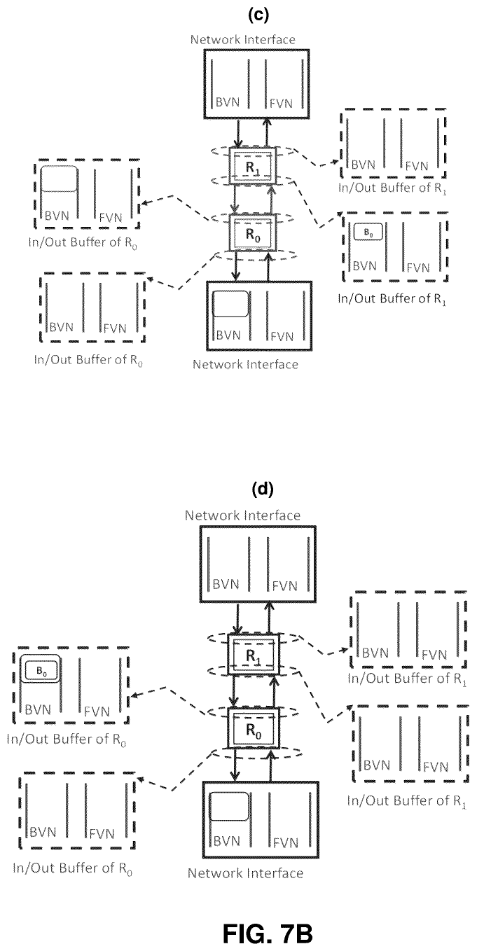

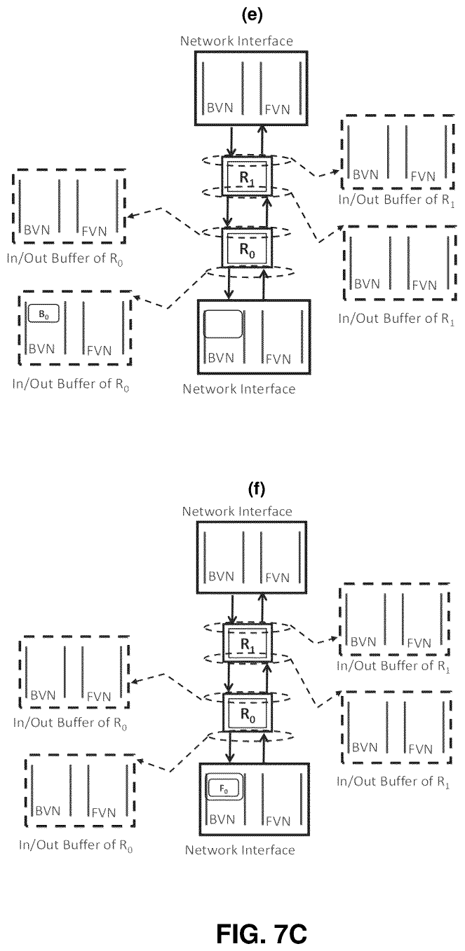

FIGS. 7A-7C demonstrate generating the backward response which uses the buffer slots reserved in FIGS. 6A-6B. As the backward response leaves the routers or NI, the pre-reserved buffer slots are released. Released buffer slots can be used to store backward packets. As shown, the backward response may not be blocked due to the lack of buffer space as buffer space is reserved to accommodate the backward response. Buffer slots can be released upon departure of the backward packet from a router.

In some examples, a router does not drop backward packets and can drop forward packets. A packet can include a flag (e.g., 1 bit) in packet header that indicates the packet is backward or forward type.

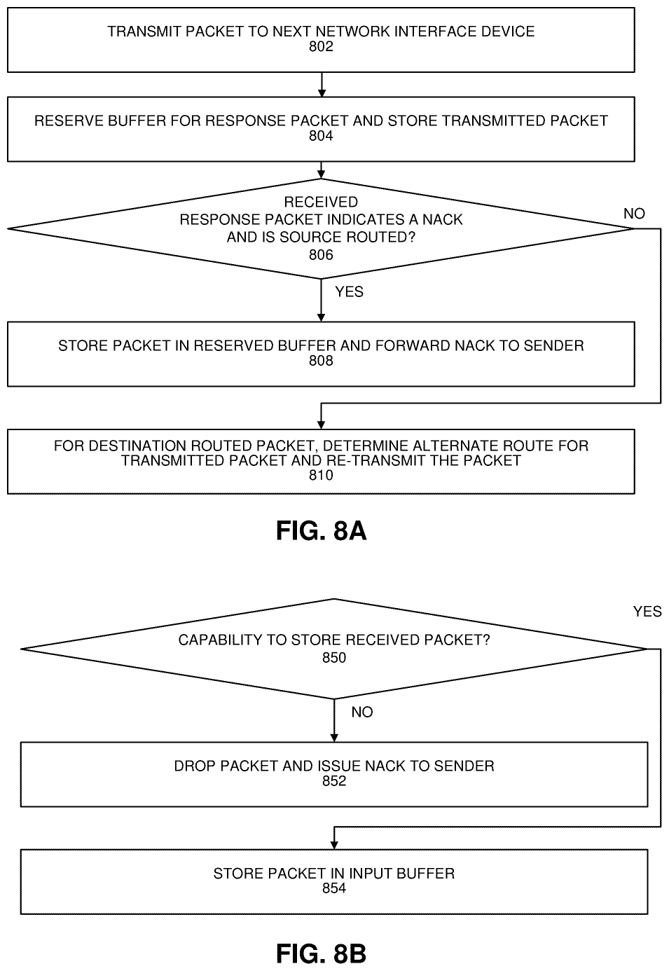

FIG. 8A depicts an example process. The process can be performed by a switch or other network interface device. At 802, a switch can transmit a packet to a next switch or network interface device even if no credits are available to indicate free buffer space in the next switch or network interface device or no credits are reported to indicate free buffer space in the next switch or network interface device. At 804, the switch can reserve space in a buffer to store a response packet to the transmitted packet. A response packet can include a control packet or indication of ACK or NACK. At 806, based on receipt of a control packet, the switch can store the response packet in the reserved space. Based on the control packet indicating a NACK for the transmitted packet and the transmitted packet being destination routed, at 808, the switch can select another path for the transmitted packet and re-transmit such packet. Based on the control packet indicating a NACK for the transmitted packet and the transmitted packet being source routed, at 810, the switch can forward the NACK to a sender of the transmitted packet.

FIG. 8B depicts an example process. The process can be performed by a switch or other network interface device. At 850, based on a receipt of a packet from an input port, the switch can determine if the packet can be stored in an input buffer. For example, the switch can determine whether the input buffer is full or has reached a threshold level of fullness to trigger dropping of the received packet. Dropping of the received packet can be based on a priority level of the received packet being too low a level. At 852, based on a determination to drop the packet, the switch can issue a NACK to sender of the packet. At 854, based on a determination to store the packet in the input buffer, the switch can store the received packet in the input buffer.

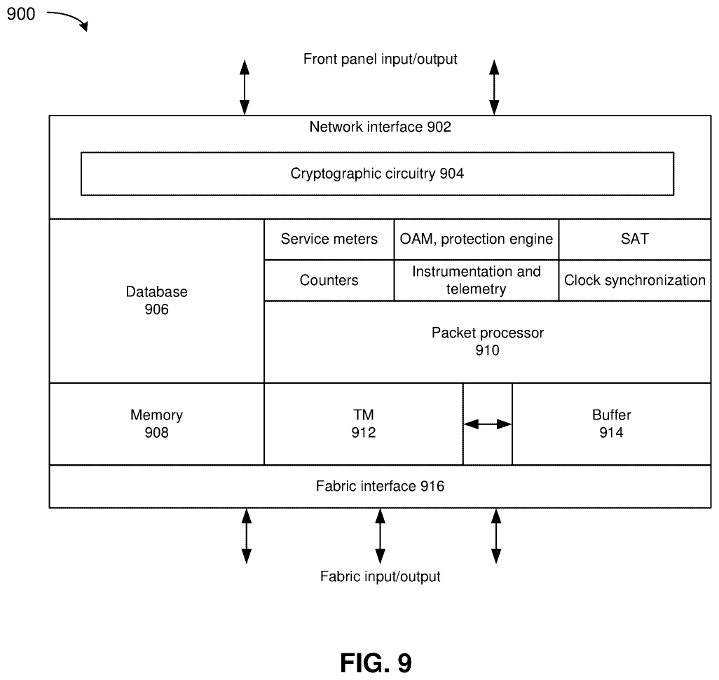

FIG. 9 depicts an example switch. Switch 900 can include circuitry and software described herein to transmit a packet without receipt of an input buffer credit, re-transmit a packet based on receipt of a NACK for such packet, and/or issue a NACK to a packet sender based on buffer overflow. Switch 900 can include a network interface 900 that can provide an Ethernet consistent interface. Network interface 900 can support for 25 GbE, 50 GbE, 100 GbE, 200 GbE, 400 GbE Ethernet port interfaces. Cryptographic circuitry 904 can perform at least Media Access Control security (MACsec) or Internet Protocol Security (IPSec) decryption for received packets or encryption for packets to be transmitted.

Various circuitry can perform one or more of: service metering, packet counting, operations, administration, and management (OAM), protection engine, instrumentation and telemetry, and clock synchronization (e.g., based on IEEE 1588).

Database 906 can store a device's profile to configure operations of switch 900. Memory 908 can include High Bandwidth Memory (HBM) for packet buffering. Packet processor 910 can perform one or more of: decision of next hop in connection with packet forwarding, packet counting, access-list operations, bridging, routing, Multiprotocol Label Switching (MPLS), virtual private LAN service (VPLS), L2VPNs, L3VPNs, OAM, Data Center Tunneling Encapsulations (e.g., VXLAN and NV-GRE), or others. Packet processor 910 can include one or more FPGAs. Buffer 914 can store one or more packets. Traffic manager (TM) 912 can provide per-subscriber bandwidth guarantees in accordance with service level agreements (SLAs) as well as performing hierarchical quality of service (QOS). Fabric interface 916 can include a serializer/de-serializer (SerDes) and provide an interface to a switch fabric.

For example, components of examples of switch 900 can be implemented in a switch system on chip (SoC) that includes at least one interface to other circuitry in a switch system. A switch SoC can be coupled to other devices in a switch system such as ingress or egress ports, memory devices, or host interface circuitry.

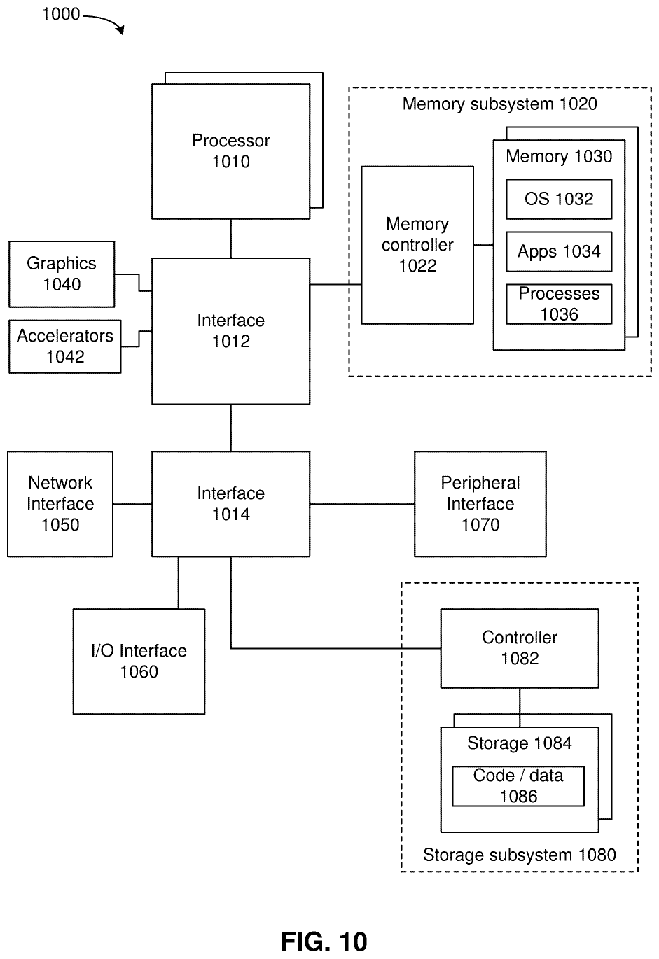

FIG. 10 depicts a system. In some examples, circuitry of network interface device can be configured to combine payload and control packets, process payload packets and control packets in separate paths, allow for egress of packets without receipt of credits from an egress port, and/or issue a NACK based on dropping a received packet, as described herein. System 1000 includes processor 1010, which provides processing, operation management, and execution of instructions for system 1000. Processor 1010 can include any type of microprocessor, central processing unit (CPU), graphics processing unit (GPU), XPU, processing core, or other processing hardware to provide processing for system 1000, or a combination of processors. An XPU can include one or more of: a CPU, a graphics processing unit (GPU), general purpose GPU (GPGPU), and/or other processing units (e.g., accelerators or programmable or fixed function FPGAs). Processor 1010 controls the overall operation of system 1000, and can be or include, one or more programmable general-purpose or special-purpose microprocessors, digital signal processors (DSPs), programmable controllers, application specific integrated circuits (ASICs), programmable logic devices (PLDs), or the like, or a combination of such devices.

In one example, system 1000 includes interface 1012 coupled to processor 1010, which can represent a higher speed interface or a high throughput interface for system components that needs higher bandwidth connections, such as memory subsystem 1020 or graphics interface components 1040, or accelerators 1042. Interface 1012 represents an interface circuit, which can be a standalone component or integrated onto a processor die. Graphics interface 1040 can provide an interface to graphics components for providing a visual display to a user of system 1000. In one example, graphics interface 1040 can drive a display that provides an output to a user. In one example, the display can include a touchscreen display. In one example, graphics interface 1040 generates a display based on data stored in memory 1030 or based on operations executed by processor 1010 or both. In one example, graphics interface 1040 generates a display based on data stored in memory 1030 or based on operations executed by processor 1010 or both.

Accelerators 1042 can be a programmable or fixed function offload engine that can be accessed or used by a processor 1010. For example, an accelerator among accelerators 1042 can provide data compression (DC) capability, cryptography services such as public key encryption (PKE), cipher, hash/authentication capabilities, decryption, or other capabilities or services. In some cases, accelerators 1042 can be integrated into a CPU socket (e.g., a connector to a motherboard or circuit board that includes a CPU and provides an electrical interface with the CPU). For example, accelerators 1042 can include a single or multi-core processor, graphics processing unit, logical execution unit single or multi-level cache, functional units usable to independently execute programs or threads, application specific integrated circuits (ASICs), neural network processors (NNPs), programmable control logic, and programmable processing elements such as field programmable gate arrays (FPGAs). Accelerators 1042 can provide multiple neural networks, CPUs, processor cores, general purpose graphics processing units, or graphics processing units can be made available for use by artificial intelligence (AI) or machine learning (ML) models. For example, the AI model can use or include any or a combination of: a reinforcement learning scheme, Q-learning scheme, deep-Q learning, or Asynchronous Advantage Actor-Critic (A3C), combinatorial neural network, recurrent combinatorial neural network, or other AI or ML model. Multiple neural networks, processor cores, or graphics processing units can be made available for use by AI or ML models to perform learning and/or inference operations.

Memory subsystem 1020 represents the main memory of system 1000 and provides storage for code to be executed by processor 1010, or data values to be used in executing a routine. Memory subsystem 1020 can include one or more memory devices 1030 such as read-only memory (ROM), flash memory, one or more varieties of random access memory (RAM) such as DRAM, or other memory devices, or a combination of such devices. Memory 1030 stores and hosts, among other things, operating system (OS) 1032 to provide a software platform for execution of instructions in system 1000. Additionally, applications 1034 can execute on the software platform of OS 1032 from memory 1030. Applications 1034 represent programs that have their own operational logic to perform execution of one or more functions. Processes 1036 represent agents or routines that provide auxiliary functions to OS 1032 or one or more applications 1034 or a combination. OS 1032, applications 1034, and processes 1036 provide software logic to provide functions for system 1000. In one example, memory subsystem 1020 includes memory controller 1022, which is a memory controller to generate and issue commands to memory 1030. It will be understood that memory controller 1022 could be a physical part of processor 1010 or a physical part of interface 1012. For example, memory controller 1022 can be an integrated memory controller, integrated onto a circuit with processor 1010.

Applications 1034 and/or processes 1036 can refer instead or additionally to a virtual machine (VM), container, microservice, processor, or other software. Various examples described herein can perform an application composed of microservices, where a microservice runs in its own process and communicates using protocols (e.g., application program interface (API), a Hypertext Transfer Protocol (HTTP) resource API, message service, remote procedure calls (RPC), or Google RPC (gRPC)). Microservices can communicate with one another using a service mesh and be executed in one or more data centers or edge networks. Microservices can be independently deployed using centralized management of these services. The management system may be written in different programming languages and use different data storage technologies. A microservice can be characterized by one or more of: polyglot programming (e.g., code written in multiple languages to capture additional functionality and efficiency not available in a single language), or lightweight container or virtual machine deployment, and decentralized continuous microservice delivery.

In some examples, OS 1032 can be Linux®, Windows® Server or personal computer, FreeBSD®, Android®, MacOS®, iOS®, VMware vSphere, openSUSE, RHEL, CentOS, Debian, Ubuntu, or any other operating system. The OS and driver can execute on a processor sold or designed by Intel®, ARM®, Advanced Micro Devices, Inc. (AMD)®, Qualcomm®, IBM®, Nvidia®, Broadcom®, Texas Instruments®, or compatible with reduced instruction set computer (RISC) instruction set architecture (ISA) (e.g., RISC-V), among others.

In some examples, OS 1032, a system administrator, and/or orchestrator can configure network interface 1050 to combine payload and control packets, process payload packets and control packets in separate paths, allow for egress of packets without receipt of credits from an egress port, and/or issue a NACK based on dropping a received packet, as described herein.

While not specifically illustrated, it will be understood that system 1000 can include one or more buses or bus systems between devices, such as a memory bus, a graphics bus, interface buses, or others. Buses or other signal lines can communicatively or electrically couple components together, or both communicatively and electrically couple the components. Buses can include physical communication lines, point-to-point connections, bridges, adapters, controllers, or other circuitry or a combination. Buses can include, for example, one or more of a system bus, a Peripheral Component Interconnect express (PCIe) bus, a Hyper Transport or industry standard architecture (ISA) bus, a small computer system interface (SCSI) bus, a universal serial bus (USB), or an Institute of Electrical and Electronics Engineers (IEEE) standard 1394 bus (Firewire).

In one example, system 1000 includes interface 1014, which can be coupled to interface 1012. In one example, interface 1014 represents an interface circuit, which can include standalone components and integrated circuitry. In one example, multiple user interface components or peripheral components, or both, couple to interface 1014. Network interface 1050 provides system 1000 the ability to communicate with remote devices (e.g., servers or other computing devices) over one or more networks. Network interface 1050 can include an Ethernet adapter, wireless interconnection components, cellular network interconnection components, USB (universal serial bus), or other wired or wireless standards-based or proprietary interfaces. Network interface 1050 can transmit data to a device that is in the same data center or rack or a remote device, which can include sending data stored in memory. Network interface 1050 can receive data from a remote device, which can include storing received data into memory. In some examples, packet processing device or network interface device 1050 can refer to one or more of: a network interface controller (NIC), a remote direct memory access (RDMA)-enabled NIC, SmartNIC, router, switch, forwarding element, infrastructure processing unit (IPU), or data processing unit (DPU).

In one example, system 1000 includes one or more input/output (I/O) interface(s) 1060. I/O interface 1060 can include one or more interface components through which a user interacts with system 1000. Peripheral interface 1070 can include any hardware interface not specifically mentioned above. Peripherals refer generally to devices that connect dependently to system 1000.

In one example, system 1000 includes storage subsystem 1080 to store data in a nonvolatile manner. In one example, in certain system implementations, at least certain components of storage 1080 can overlap with components of memory subsystem 1020. Storage subsystem 1080 includes storage device(s) 1084, which can be or include any conventional medium for storing large amounts of data in a nonvolatile manner, such as one or more magnetic, solid state, or optical based disks, or a combination. Storage 1084 holds code or instructions and data 1086 in a persistent state (e.g., the value is retained despite interruption of power to system 1000). Storage 1084 can be generically considered to be a “memory,” although memory 1030 is typically the executing or operating memory to provide instructions to processor 1010. Whereas storage 1084 is nonvolatile, memory 1030 can include volatile memory (e.g., the value or state of the data is indeterminate if power is interrupted to system 1000). In one example, storage subsystem 1080 includes controller 1082 to interface with storage 1084. In one example controller 1082 is a physical part of interface 1014 or processor 1010 or can include circuits or logic in both processor 1010 and interface 1014.

A volatile memory is memory whose state (and therefore the data stored in it) is indeterminate if power is interrupted to the device. A non-volatile memory (NVM) device is a memory whose state is determinate even if power is interrupted to the device.

In an example, system 1000 can be implemented using interconnected compute sleds of processors, memories, storages, network interfaces, and other components. High speed interconnects can be used such as: Ethernet (IEEE 802.3), remote direct memory access (RDMA), InfiniBand, Internet Wide Area RDMA Protocol (iWARP), Transmission Control Protocol (TCP), User Datagram Protocol (UDP), quick UDP Internet Connections (QUIC), RDMA over Converged Ethernet (ROCE), Peripheral Component Interconnect express (PCIe), Intel QuickPath Interconnect (QPI), Intel Ultra Path Interconnect (UPI), Intel On-Chip System Fabric (IOSF), Omni-Path, Compute Express Link (CXL), HyperTransport, high-speed fabric, NVLink, Advanced Microcontroller Bus Architecture (AMBA) interconnect, OpenCAPI, Gen-Z, Infinity Fabric (IF), Cache Coherent Interconnect for Accelerators (CCIX), 3GPP Long Term Evolution (LTE) (4G), 3GPP 5G, and variations thereof. Data can be copied or stored to virtualized storage nodes or accessed using a protocol such as NVMe over Fabrics (NVMe-oF) or NVMe (e.g., a non-volatile memory express (NVMe) device can operate in a manner consistent with the Non-Volatile Memory Express (NVMe) Specification, revision 1.3c, published on May 24, 2018 (“NVMe specification”) or derivatives or variations thereof).

Communications between devices can take place using a network that provides die-to-die communications; chip-to-chip communications; circuit board-to-circuit board communications; and/or package-to-package communications.

In an example, system 1000 can be implemented using interconnected compute sleds of processors, memories, storages, network interfaces, and other components. High speed interconnects can be used such as PCIe, Ethernet, or optical interconnects (or a combination thereof).

Examples herein may be implemented in various types of computing and networking equipment, such as switches, routers, racks, and blade servers such as those employed in a data center and/or server farm environment. The servers used in data centers and server farms comprise arrayed server configurations such as rack-based servers or blade servers. These servers are interconnected in communication via various network provisions, such as partitioning sets of servers into Local Area Networks (LANs) with appropriate switching and routing facilities between the LANs to form a private Intranet. For example, cloud hosting facilities may typically employ large data centers with a multitude of servers. A blade comprises a separate computing platform that is configured to perform server-type functions, that is, a “server on a card.” Accordingly, a blade includes components common to conventional servers, including a main printed circuit board (main board) providing internal wiring (e.g., buses) for coupling appropriate integrated circuits (ICs) and other components mounted to the board.

Various examples may be implemented using hardware elements, software elements, or a combination of both. In some examples, hardware elements may include devices, components, processors, microprocessors, circuits, circuit elements (e.g., transistors, resistors, capacitors, inductors, and so forth), integrated circuits, ASICs, PLDs, DSPs, FPGAs, memory units, logic gates, registers, semiconductor device, chips, microchips, chip sets, and so forth. In some examples, software elements may include software components, programs, applications, computer programs, application programs, system programs, machine programs, operating system software, middleware, firmware, software modules, routines, subroutines, functions, methods, procedures, software interfaces, APIs, instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation. A processor can be one or more combination of a hardware state machine, digital control logic, central processing unit, or any hardware, firmware and/or software elements.

Some examples may be implemented using or as an article of manufacture or at least one computer-readable medium. A computer-readable medium may include a non-transitory storage medium to store logic. In some examples, the non-transitory storage medium may include one or more types of computer-readable storage media capable of storing electronic data, including volatile memory or non-volatile memory, removable or non-removable memory, erasable or non-erasable memory, writeable or re-writeable memory, and so forth. In some examples, the logic may include various software elements, such as software components, programs, applications, computer programs, application programs, system programs, machine programs, operating system software, middleware, firmware, software modules, routines, subroutines, functions, methods, procedures, software interfaces, API, instruction sets, computing code, computer code, code segments, computer code segments, words, values, symbols, or any combination thereof.

According to some examples, a computer-readable medium may include a non-transitory storage medium to store or maintain instructions that when executed by a machine, computing device or system, cause the machine, computing device or system to perform methods and/or operations in accordance with the described examples. The instructions may include any suitable type of code, such as source code, compiled code, interpreted code, executable code, static code, dynamic code, and the like. The instructions may be implemented according to a predefined computer language, manner or syntax, for instructing a machine, computing device or system to perform a certain function. The instructions may be implemented using any suitable high-level, low-level, object-oriented, visual, compiled and/or interpreted programming language.

One or more aspects of at least one example may be implemented by representative instructions stored on at least one machine-readable medium which represents various logic within the processor, which when read by a machine, computing device or system causes the machine, computing device or system to fabricate logic to perform the techniques described herein. Such representations, known as “IP cores” may be stored on a tangible, machine readable medium and supplied to various customers or manufacturing facilities to load into the fabrication machines that actually make the logic or processor.

The appearances of the phrase “one example” or “an example” are not necessarily all referring to the same example or embodiment. Any aspect described herein can be combined with any other aspect or similar aspect described herein, regardless of whether the aspects are described with respect to the same figure or element. Division, omission, or inclusion of block functions depicted in the accompanying figures does not infer that the hardware components, circuits, software and/or elements for implementing these functions would necessarily be divided, omitted, or included in embodiments.

Some examples may be described using the expression “coupled” and “connected” along with their derivatives. For example, descriptions using the terms “connected” and/or “coupled” may indicate that two or more elements are in direct physical or electrical contact. The term “coupled,” however, may also mean that two or more elements are not in direct contact, but yet still co-operate or interact.

The terms “first,” “second,” and the like, herein do not denote any order, quantity, or importance, but rather are used to distinguish one element from another. The terms “a” and “an” herein do not denote a limitation of quantity, but rather denote the presence of at least one of the referenced items. The term “asserted” used herein with reference to a signal denote a state of the signal, in which the signal is active, and which can be achieved by applying any logic level either logic 0 or logic 1 to the signal. The terms “follow” or “after” can refer to immediately following or following after some other event or events. Other sequences of operations may also be performed according to alternative embodiments. Furthermore, additional operations may be added or removed depending on the particular applications. Any combination of changes can be used and one of ordinary skill in the art with the benefit of this disclosure would understand the many variations, modifications, and alternative embodiments thereof.

Disjunctive language such as the phrase “at least one of X, Y, or Z,” unless specifically stated otherwise, is otherwise understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to be present. Additionally, conjunctive language such as the phrase “at least one of X, Y, and Z,” unless specifically stated otherwise, should also be understood to mean X, Y, Z, or any combination thereof, including “X, Y, and/or Z.”’

Illustrative examples of the devices, systems, and methods disclosed herein are provided below. An embodiment of the devices, systems, and methods may include any one or more, and any combination of, the examples described below.

Example 1 includes one or more examples, and includes a first interface to an input port; a second interface to an output port; switch circuitry, coupled to the first interface and the second interface, wherein the switch circuitry is to: based on receipt of a control packet associated with a first link, store the control packet into a first region of memory associated with the first link; based on receipt of a data packet associated with the first link, store the data packet into a second region of memory associated with the first link; based on the control packet and data packet to egress from a same output port, insert a strict subset of content of the control packet into the data packet to form a second data packet; and cause transmission of the second data packet to a device from the output port.

Example 2 includes one or more examples, wherein the strict subset of content of the control packet comprises an indication of packet receipt (ACK) or non-receipt (NACK) and a tag that is to identify an entry that comprises routing information of the control packet and is stored in a downstream switch.

Example 3 includes one or more examples, wherein the tag and the routing information are associated with a forward packet received by the circuitry and wherein the control packet comprises a response to the forward packet.

Example 4 includes one or more examples, wherein the second data packet comprises an indication of packet receipt (ACK) or non-receipt (NACK) from the control packet and a tag that is to reference routing information for the control packet in a downstream switch and wherein the downstream switch is to reconstruct the control packet based on retrieval of the routing information referenced by the tag.

Example 5 includes one or more examples, wherein the switch circuitry is to: based on receipt of a second control packet associated with a second link, store the second control packet into a third region of memory associated with the second link; based on receipt of a third data packet associated with the second link, store the second data packet into a fourth region of memory associated with the second link; combine content of the second control packet into the third data packet to form a third data packet; and cause transmission of the third data packet to a destination via the second link.

Example 6 includes one or more examples, wherein the switch circuitry is to: transmit the packet irrespective of credit count or buffer occupancy of a receiver network interface device.

Example 7 includes one or more examples, wherein the switch circuitry is to: based on receipt of a packet and congestion in a buffer that is to store the received packet, drop the received packet and send a negative acknowledgement (NACK) to a sender of the packet.

Example 8 includes one or more examples, wherein the switch circuitry is to: based on receipt of an indication of packet non-receipt: for a first setting of destination routing, re-transmit the packet to a destination network interface device and for a second setting of source routing, forward the indication of packet non-receipt to a sender of the packet.

Example 9 includes one or more examples, wherein the packet comprises a control packet or a data packet.

Example 10 includes one or more examples, wherein the switch circuitry is to reserve a space in a buffer for a response to a transmitted packet.

Example 11 includes one or more examples, wherein a mesh, network on chip (NoC), or off-chip network comprise the switch.

Example 12 includes one or more examples, and includes a method that includes: configuring one or more switch in a network to: at a first switch of the one or more switches: based on receipt of a first data packet, storing routing information of the first data packet into an entry and associating a tag with the entry and at a second switch of the one or more switches: for a control packet and a second data packet that are to egress an output port, combining a strict subset of the control packet into the second data packet and egressing the second data packet with the strict subset of the control packet to the first switch, wherein: the control packet comprises a response to the first data packet and the strict subset of the control packet comprises an indication of packet receipt (ACK) or non-receipt (NACK) and a tag that is to identify an entry that comprises routing information of the control packet and is stored in a first switch.

Example 13 includes one or more examples, and includes: the first switch: retrieving the entry by reference to the tag; reconstructing the control packet based on the stored in the routing information; and based on receipt of a third data packet: storing routing information of the third data packet into a second entry, associating a second tag with the second entry, and combining the control packet with the third data packet based on the control packet and the third packet egressing a same output port.

Example 14 includes one or more examples, that includes: the second switch egressing the second data packet irrespective of credit count or buffer occupancy of a receiver network interface device.

Example 15 includes one or more examples, that includes: the second switch: based on receipt of an indication of packet non-receipt: for a first setting of destination routing, re-transmitting the packet to a destination network interface device and for a second setting of source routing, forwarding the indication of packet non-receipt to a sender of the packet.

Example 16 includes one or more examples, and includes at least one computer-readable medium that includes instructions stored thereon, that if executed by one or more circuitry of a router, cause the one or more circuitry of the router to: based on receipt of a control packet associated with a first link, store the control packet into a first region of memory associated with the first link; based on receipt of a data packet associated with the first link, store the data packet into a second region of memory associated with the first link; based on the control packet and data packet to egress from a same output port, insert a strict subset of content of the control packet into the data packet to form a second data packet; and cause transmission of the second data packet to a device from the output port.

Example 17 includes one or more examples, wherein the strict subset of content of the control packet comprises an indication of packet receipt (ACK) or non-receipt (NACK) and a tag that is to identify an entry that comprises routing information of the control packet and is stored in the device.

Example 18 includes one or more examples, wherein the second data packet comprises an indication of packet receipt (ACK) or non-receipt (NACK) from the control packet and a tag that is to reference routing information for the control packet in a downstream switch and wherein the downstream switch is to reconstruct the control packet based on retrieval of the routing information referenced by the tag.

Example 19 includes one or more examples, that includes instructions stored thereon, that if executed by one or more circuitry of a router, cause the one or more circuitry of the router to: transmit the second data packet irrespective of credit count or buffer occupancy of the device.

Example 20 includes one or more examples, that includes instructions stored thereon, that if executed by one or more circuitry of a router, cause the one or more circuitry of the router to: based on receipt of an indication of packet non-receipt: for a first setting of destination routing, re-transmit the second data packet to a destination network interface device and for a second setting of source routing, forward the indication of packet non-receipt to a sender of the data packet.

1. An apparatus comprising:
a first interface to an input port;
a second interface to an output port;
switch circuitry, coupled to the first interface and the second interface, wherein the switch circuitry is to:
based on receipt of a control packet associated with a first link, store the control packet into a first region of memory associated with the first link;
based on receipt of a data packet associated with the first link, store the data packet into a second region of memory associated with the first link;
based on the control packet and data packet to egress from a same output port, insert a strict subset of content of the control packet into the data packet to form a second data packet; and
cause transmission of the second data packet to a device from the output port.

2. The apparatus of claim 1, wherein the strict subset of content of the control packet comprises an indication of packet receipt (ACK) or non-receipt (NACK) and a tag that is to identify an entry that comprises routing information of the control packet and is stored in a downstream switch.

3. The apparatus of claim 2, wherein the tag and the routing information are associated with a forward packet received by the circuitry and wherein the control packet comprises a response to the forward packet.

4. The apparatus of claim 1, wherein the second data packet comprises an indication of packet receipt (ACK) or non-receipt (NACK) from the control packet and a tag that is to reference routing information for the control packet in a downstream switch and wherein the downstream switch is to reconstruct the control packet based on retrieval of the routing information referenced by the tag.

5. The apparatus of claim 1, wherein the switch circuitry is to:
based on receipt of a second control packet associated with a second link, store the second control packet into a third region of memory associated with the second link;
based on receipt of a third data packet associated with the second link, store the second data packet into a fourth region of memory associated with the second link;
combine content of the second control packet into the third data packet to form a third data packet; and
cause transmission of the third data packet to a destination via the second link.

6. The apparatus of claim 1, wherein the switch circuitry is to:
transmit the packet irrespective of credit count or buffer occupancy of a receiver network interface device.

7. The apparatus of claim 1, wherein the switch circuitry is to:
based on receipt of a packet and congestion in a buffer that is to store the received packet, drop the received packet and send a negative acknowledgement (NACK) to a sender of the packet.

8. The apparatus of claim 1, wherein the switch circuitry is to:
based on receipt of an indication of packet non-receipt:
for a first setting of destination routing, re-transmit the packet to a destination network interface device and
for a second setting of source routing, forward the indication of packet non-receipt to a sender of the packet.

9. The apparatus of claim 8, wherein the packet comprises a control packet or a data packet.

10. The apparatus of claim 1, wherein the switch circuitry is to reserve a space in a buffer for a response to a transmitted packet.

11. The apparatus of claim 1, wherein a mesh, network on chip (NoC), or off-chip network comprise the switch.

12. A method comprising:
configuring one or more switch in a network to:
at a first switch of the one or more switches:
based on receipt of a first data packet, storing routing information of the first data packet into an entry and associating a tag with the entry and at a second switch of the one or more switches:
for a control packet and a second data packet that are to egress an output port, combining a strict subset of the control packet into the second data packet and egressing the second data packet with the strict subset of the control packet to the first switch, wherein:
the control packet comprises a response to the first data packet and
the strict subset of the control packet comprises an indication of packet receipt (ACK) or non-receipt (NACK) and a tag that is to identify an entry that comprises routing information of the control packet and is stored in a first switch.

13. The method of claim 12, comprising:
the first switch:
retrieving the entry by reference to the tag;
reconstructing the control packet based on the stored in the routing information; and
based on receipt of a third data packet:
storing routing information of the third data packet into a second entry,
associating a second tag with the second entry, and
combining the control packet with the third data packet based on the control packet and the third packet egressing a same output port.

14. The method of claim 12, comprising:
the second switch egressing the second data packet irrespective of credit count or buffer occupancy of a receiver network interface device.

15. The method of claim 12, comprising:
the second switch:
based on receipt of an indication of packet non-receipt:
for a first setting of destination routing, re-transmitting the packet to a destination network interface device and
for a second setting of source routing, forwarding the indication of packet non-receipt to a sender of the packet.

16. At least one computer-readable medium comprising instructions stored thereon, that if executed by one or more circuitry of a router, cause the one or more circuitry of the router to:
based on receipt of a control packet associated with a first link, store the control packet into a first region of memory associated with the first link;
based on receipt of a data packet associated with the first link, store the data packet into a second region of memory associated with the first link;
based on the control packet and data packet to egress from a same output port, insert a strict subset of content of the control packet into the data packet to form a second data packet; and
cause transmission of the second data packet to a device from the output port.

17. The computer-readable medium of claim 16, wherein the strict subset of content of the control packet comprises an indication of packet receipt (ACK) or non-receipt (NACK) and a tag that is to identify an entry that comprises routing information of the control packet and is stored in the device.

18. The computer-readable medium of claim 17, wherein the second data packet comprises an indication of packet receipt (ACK) or non-receipt (NACK) from the control packet and a tag that is to reference routing information for the control packet in a downstream switch and wherein the downstream switch is to reconstruct the control packet based on retrieval of the routing information referenced by the tag.

19. The computer-readable medium of claim 17, comprising instructions stored thereon, that if executed by one or more circuitry of a router, cause the one or more circuitry of the router to:
transmit the second data packet irrespective of credit count or buffer occupancy of the device.

20. The computer-readable medium of claim 17, comprising instructions stored thereon, that if executed by one or more circuitry of a router, cause the one or more circuitry of the router to:
based on receipt of an indication of packet non-receipt:
for a first setting of destination routing, re-transmit the second data packet to a destination network interface device and
for a second setting of source routing, forward the indication of packet non-receipt to a sender of the data packet.
